(19) United States
(12) Patent Application Publication
(10) Pub. No.: US 2022/0082104 A1
(43) Pub. Date: Mar. 17, 2022

(54) Hydraulic fan drive

(71) Applicant: Robert Bosch GmbH, Stuttgart (DE)

(72) Inventor: Andreas Apperger, Eutingen (DE)

(21) Appl. No.: 17/469,524

(22) Filed: Sep. 8, 2021

(30) Foreign Application Priority Data
Sep. 9, 2020 (DE) 10 2020 211 285.1

(51) Int. Cl. F04D 25/04; F04B 15/02; F04B 49/12; F15B 7/08

(52) U.S. Cl. CPC F04D 25/04; F15B 7/08; F04B 49/12; F04B 15/02

(57) ABSTRACT

A hydraulic fan drive includes an adjustable variable-displacement pump by which a pressurized fluid can be sucked in and can be delivered via a pump pressure port and which has, for adjustment of the delivery volume, an adjustment device with an actuation chamber, which is delimited by an actuation surface of an adjustment piston and to which a pressurized fluid can be supplied for increasing the delivery volume and from which pressurized fluid can be displaced for reducing the delivery volume. The adjustment device further includes a counter chamber, which is delimited by a counter surface, smaller in cross section in comparison with the actuation surface, of an adjustment piston and can be acted on by pump pressure. The adjustment device also includes an actuation spring, which acts so as to adjust the delivery volume toward an extreme value.

The invention relates to a hydraulic fan drive having a variable-displacement pump which can be adjusted in terms of its delivery volume and by which a pressurized fluid can be sucked in via a suction port and can be delivered via a pump pressure port. For the adjustment of the delivery volume, the variable-displacement pump has an adjustment device with an actuation chamber, which is delimited by an actuation surface of an adjustment piston and which can be acted on by an actuation pressure and to which a pressurized fluid can be supplied for the purpose of increasing the delivery volume and from which, under the action of a force generated by the pump pressure, pressurized fluid can be displaced for the purpose of reducing the delivery volume. An actuation spring acts so as to adjust the delivery volume toward an extreme value. The actuation pressure can be regulated by a pressure-regulating valve which can be adjusted proportionally by a proportional electromagnet and which has a valve pressure port fluidically connected to the pump pressure port, has a tank port and has a regulation port at which the actuation pressure prevails and which is fluidically connected to the actuation chamber. A regulating piston of the pressure-regulating valve is acted on by a pressure force exerted by the actuation pressure, by a magnetic force generated by the proportional electromagnet, and by a spring force exerted by a spring.

With an equilibrium of the forces acting on it, the regulating piston assumes a regulation position in which it shuts off the regulation port with respect to the valve pressure port and the tank port. If the magnitude of the electric current flowing through the proportional electromagnet is changed, the regulating piston exits the regulation position. Outside the regulation position, the regulating piston connects the regulation port to the valve pressure port or to the tank port.

An essential feature of a fan drive is that the torque which is to be applied for the drive of the fan impeller increases with the rotational speed of the fan impeller. Thus, in the case of a hydraulic fan, the rotational speed of a fan impeller driven by a hydraulic motor with a constant displacement volume and thus the cooling action can be set through control of the pump pressure. If a certain pump pressure is predefined, then the variable-displacement pump changes the delivery volume and thus also the rotational speed of the fan impeller until the predefined pump pressure is set.

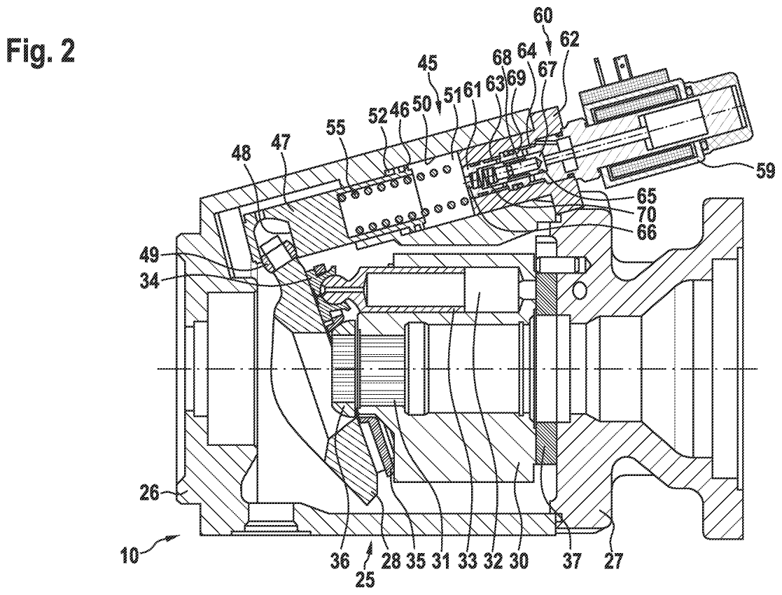

A hydraulic fan drive of the type outlined in the introduction is known from DE 100 28 416 A1, FIG. 2, wherein the actuation spring acts in the direction of minimum delivery volume of the variable-displacement pump.

The invention is based on the object of further developing a hydraulic fan drive having the features stated in the introduction so as to obtain a function which is improved in comparison with the stated prior art.

Said object is achieved according to the invention in the case of a hydraulic fan drive having the features stated in the introduction in that the actuation spring acts so as to adjust the delivery volume toward its maximum value.

In the case of a hydraulic fan drive according to the invention, after a standstill, the variable-displacement pump builds up a pump pressure at the beginning of its operation, so that the delivery volume is reduced. Ultimately, the pump pressure is of such a magnitude that the force generated by the pump pressure is equal to the spring force. The delivery volume is then very small. A stop of some kind or other for a minimum delivery volume is not necessary. It is possible to generate from the pump pressure an actuation pressure which, together with the actuation spring, acts toward an enlargement of the delivery volume of the variable-displacement pump and thus the pump pressure, so that an adjustment of the variable-displacement pump up to the maximum delivery volume is possible.

A hydraulic fan drive according to the invention may advantageously be further configured.

In the case of a swashplate-type axial piston pump, an action of the pump pressure toward a reduction of the delivery volume can be achieved in that the pivot axis, lying in a plane perpendicular to the axis of rotation of a cylinder drum, of the swashplate is at a distance from the axis of rotation of a cylinder drum in which the displacement pistons are arranged axially. The displacement pistons currently performing delivery, which are acted on by pump pressure, then generate in combination an internal moment acting on the swashplate whose size is dependent on the pump pressure. Through corresponding selection of the side toward which the pivot axis is offset in relation to the axis of rotation, it can be achieved that the moment acts toward a reduction in the oblique position of the swashplate.

Of particular preference is a configuration in which a counter chamber is acted on by the pump pressure, said counter chamber being delimited by a counter surface of an adjustment piston that is smaller in cross section in comparison with the actuation surface. This solution can be used in a wide variety of designs of variable-displacement pumps. Moreover, the force generated by the pump pressure pulsates only to a small extent.

It is favorable for the actuation chamber and the counter chamber to be situated on opposite sides of a single adjustment piston, which is in the form of a differential piston and which has on the side of the counter chamber a piston rod, via which said adjustment piston is mechanically coupled to a pump component which determines, by way of its position, the delivery volume of the variable-displacement pump. The counter chamber may, per se, also adjoin a second piston, a so-called counter piston. Then, however, provision is to be made in the variable-displacement pump of structural space for the adjustment piston and for the counter piston, and the machining and the assembly are more cumbersome than in the case of only an actuating piston being present.

The pressure-regulating valve is advantageously in the form of a cartridge valve with an insertion cartridge and is inserted into a housing bore of the housing of the variable-displacement pump in a manner coaxial with the adjustment piston, which delimits the actuation chamber by way of an actuation surface, wherein the actuation spring is clamped between the adjustment piston and the pressure-regulating valve. The the insertion cartridge may be received in an outer valve housing and, in a manner closing off, together with said outer valve housing, the housing bore, be inserted into the latter.

The insertion cartridge may comprise an insertion sleeve having a central longitudinal bore which is open axially toward the actuation chamber and in which the regulating piston can be moved axially and whose opening forms the regulation port of the pressure-regulating valve. The regulating piston is advantageously a hollow piston with a central blind bore which extends in the longitudinal direction and which is likewise open toward the actuation chamber and which can be connected by way of at least one radial aperture through the regulating piston to the valve pressure port and to the tank port. The actuation pressure acts on the regulating piston in the direction of a connection of the blind bore, and thus of the regulation port, to the tank port.

If a valve spring acts on the regulating piston together with the actuation pressure in the direction of a connection of the blind bore, and thus of the regulation port, to the tank port, and if the proportional electromagnet acts on the regulating piston in a pushing manner in the direction of a connection of the blind bore, and thus of the regulation port, to the valve pressure port, then the greater the electrical energization of the proportional electromagnet is, the higher the actuation pressure for which an adjustment is made will be. The pressure-regulating valve has an upward-sloping characteristic curve and the larger the current flowing through the proportional electromagnet is, the higher the rotational speed of a fan impeller will be.

If a high-strength valve spring acts on the regulating piston counter to the actuation pressure in the direction of a connection of the regulation port to the valve pressure port and the proportional electromagnet acts on the regulating piston together with the actuation pressure in the direction of a connection of the regulation port to the tank port, then the smaller the electric current flowing through the proportional electromagnet, the higher the actuation pressure will be. The pressure-regulating valve then has a downward-sloping characteristic curve. The rotational speed of the fan impeller is maximal when the proportional electromagnet is not in an electrically energized state.

The proportional electromagnet may act on the regulating piston together with the actuation pressure in a pushing or pulling manner in the direction of a connection of the regulation port to the tank port.

The circuit diagram of an example of a hydraulic fan drive according to the invention, a variable-displacement pump with a pressure-regulating valve with an upward-sloping characteristic curve, and a pressure-regulating valve with a downward-sloping characteristic curve for use instead of the pressure-regulating valve with an upward-sloping characteristic curve are illustrated in the drawings. The invention will now be discussed on the basis of said drawings.

In the drawings:

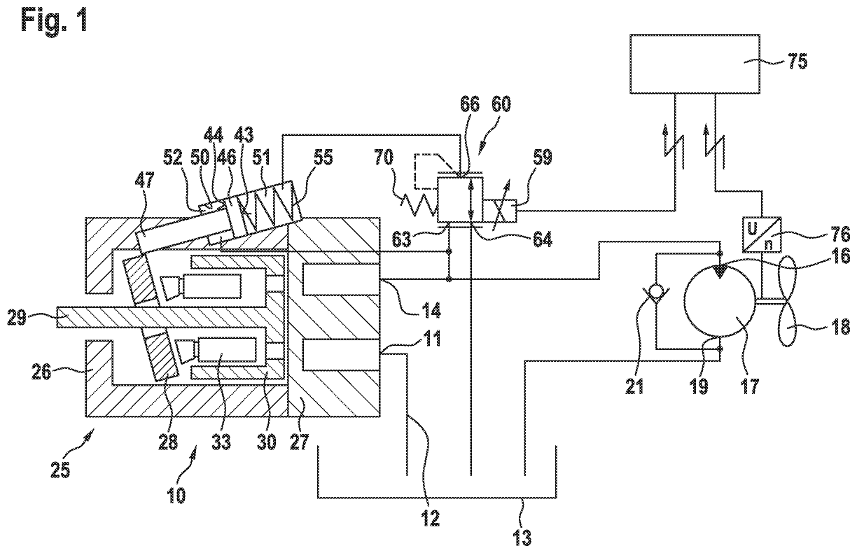

FIG. 1 shows a circuit diagram of the hydraulic fan drive,

FIG. 2 shows a partial section in a longitudinal direction through the variable-displacement pump of the hydraulic fan drive with a first pressure-regulating valve,

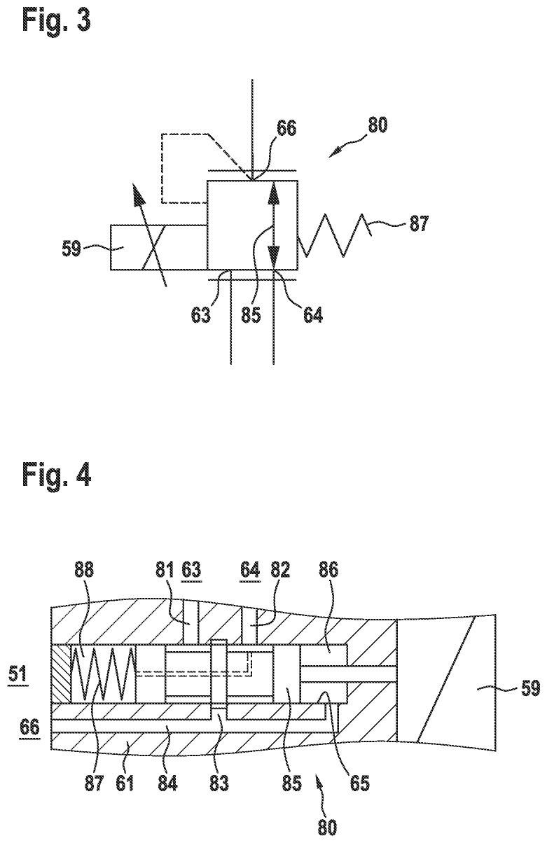

FIG. 3 shows the circuit diagram of a pressure-regulating valve with a downward-sloping characteristic curve, and

FIG. 4 shows the pressure-regulating valve in FIG. 3 in a design configuration.

According to FIG. 1, the hydraulic fan drive has a variable-displacement pump 10 which can be adjusted in terms of its swept volume, said variable-displacement pump being in the form of a swashplate-type axial piston pump in the present case. The swept volume is the fluid volume which is delivered by the variable-displacement pump per revolution. A suction port 11 of the variable-displacement pump 10 is fluidically connected via a suction line 12 to a tank 13. A pressure port 14 of the variable-displacement pump 10 is fluidically connected via a pressure line 15 to a pressure port 16 of a hydraulic motor 17, which has a constant displacement volume and through which, as a consequence, the fluid volume flowing through per revolution is always the same. A fan impeller 18 can be driven by the hydraulic motor 17. A tank port 19 of the hydraulic motor 17 is fluidically connected via a tank line 20 to the tank 13. Arranged in the bypass for the hydraulic motor 17 is a check valve 21 which opens toward the pressure port 16 from the tank port 19. With a follow-on movement of the hydraulic motor after a reduction or a complete cessation of the supply of pressurized fluid from the variable-displacement pump 10, via the check valve 21, pressurized fluid can flow from the tank port 19 to the pressure port 16. Cavitation in the hydraulic motor is avoided.

According to the fan characteristic curve, which indicates the relationship between the rotational speed of the fan impeller 18 and the torque necessary for driving the fan impeller at the given rotational speed, the torque required for driving increases with increasing rotational speed of the fan impeller 18. The torque exerted by the hydraulic motor 17 is determined by the product of the displacement volume, which is constant in the present case, and the pressure difference between the pressure port 16 and the tank port 19. Since the pressure at the tank port 19 is at least approximately constant, the rotational speed of the fan impeller 18 is set in a manner dependent on the pressure prevailing at the pressure port 16 of the hydraulic motor 17 and thus in a manner dependent on the pressure prevailing in the pressure line 15 and at the pressure port 14 of the variable-displacement pump 10. The rotational speed of the fan impeller 18 can thus be varied by regulation of the variable-displacement pump 10 to different pump pressures.

The variable-displacement pump, as already mentioned, is a swashplate-type axial piston pump and has a two-part housing 25 with a housing pot 26 and with a port plate 27 which closes off the housing pot on the open side thereof and on which the pressure port 14 and the suction port 11 are formed. Departing from the pressure port 14 and from the suction port 11 in each case is a channel (not shown in any more detail), which opens out in a kidney-shaped opening on the inner side of the port plate 27. A swashplate 28 is pivotably mounted in two bearing shells which are inserted into the housing pot 26. Centrally, the swashplate has a large opening for the passage of a drive shaft 29, which is schematically illustrated in FIG. 1 and is omitted in FIG. 2. The drive shaft 29 protrudes from the base of the housing pot 26 and is rotatably mounted in the base and in the port plate 27. The pivot axis of the swashplate 28 intersects the axis of the drive shaft 29 at a right angle and extends perpendicularly to the plane of the drawing in FIG. 2.

A cylinder drum 30 is also received by the housing pot 26 and is connected via an inner toothing 31 in a rotationally conjoint but axially movable manner to the drive shaft 29. The cylinder drum 30, extending parallel to the drive shaft, piston bores 32 into which displacement pistons 33 dip in a longitudinally movable manner. Each displacement piston 33 can be supported against a running surface of the swashplate 28 via a sliding shoe 34 which is held on a spherical piston head of a displacement piston 33 so as to be movable in all directions. In order that the displacement pistons 33, after a displacement stroke, during which they are pushed into the piston bores, remain securely on the running surface of the swashplate 28, and move out of the piston bores, during the suction stroke, a retraction plate 35 bears on a shoulder of the sliding shoes 34 and is pushed against the shoulders of the sliding shoes 34 by a retraction ball 36 in the form of a spherical layer. The retraction ball 36, in turn, is pushed against the retraction plate by a spring (not illustrated in any more detail), which spring is clamped between the retraction ball 36 and the cylinder drum 30. Under the action of the stated spring, the cylinder drum 30 bears against a control plate 37, which is held at the inside against the port plate 27 so as to be non-rotatable and has two kidney-shaped apertures, of which one covers the kidney-shaped opening of the channel leading to the pressure port, and the other covers the kidney-shaped opening of the channel leading to the suction port, in the port plate 27. The piston bores 32 open into control slots 38 at that face surface of the cylinder drum 30 which bears against the control plate 37, so that, during a rotation movement of the cylinder drum 30, each piston bore is connected, so as to be alternately open with respect to the one and the other kidney-shaped aperture in the control plate 37, and thus in an alternating manner, to the pressure port 14 and to the suction port 11 of the variable-displacement pump 10.

For regulation to different pump pressures, the variable-displacement pump 10 has an adjustment device 45 which comprises a double-action adjustment piston 46 which is in the form of a differential piston with two effective surfaces of different size, of which the larger one is the actuation surface 43 and the smaller one is the counter surface 44. The adjustment piston 46 has a piston rod 47 with a transverse bore 48 into which a spherical cap 49 held on an extension of the swashplate 28 dips. The adjustment piston 46 is guided, by way of its piston part and by way of its piston rod, in a longitudinally movable manner in a stepped housing bore 50 extending slightly obliquely with respect to the axis of the drive shaft and, during a longitudinal movement, carries the spherical cap 49 of the swashplate 28 along, so that the latter is pivoted. The spherical cap 49 in this case moves in a plane which is perpendicular to the pivot axis of the swashplate 28.

The piston part of the adjustment piston 46 divides that portion of the housing bore 50 with the larger diameter into an actuation chamber 51, whose cross section corresponds to the cross section of the housing bore and of the actuation surface 43 of the adjustment piston 46, and into a counter chamber 52, which has an annular cross section whose outer diameter is equal to the diameter of the housing bore and whose inner diameter is equal to the outer diameter of the piston rod 47 and which corresponds to the counter surface 44 of the adjustment piston 46. The actuation surface 43 is approximately three times as large as the counter surface 44. The counter chamber 52 is permanently fluidically connected to the pressure port of the variable-displacement pump 10. The pump pressure thus prevails in the counter chamber 52. This generates a force on the annular counter surface 44 of the adjustment piston 46 that acts in the direction of a retraction of the piston rod 47 and in the direction of a reduction of the oblique position of the swashplate 28 and thus a reduction in the delivery volume of the variable-displacement pump 10.

The adjustment device 45 furthermore comprises an actuation spring 55 which is in the form of a helical compression spring and which is accommodated in the actuation chamber 51. The actuation spring 55 is supported at one side against the adjustment piston 46 and at the other side in a manner fixed with respect to the housing, thus acting on the adjustment piston counter to the pump pressure in the direction of extension of the piston rod 47 and in the direction of an increasing of the oblique position of the swashplate 28 and thus an enlargement of the delivery volume of the variable-displacement pump 10.

The actuation pressure in the actuation chamber 51 can be regulated with the aid of a pressure-regulating valve 60, which comprises a proportional electromagnet 59 by way of which said valve is continuously adjustable. The pressure-regulating valve 60 is in the form of a screw-in valve with a valve sleeve 61 which is screwed into a closure screw 62, which closure screw is in turn screwed into the housing bore 50 and closes off the latter together with the pressure-regulating valve 60. Situated on the outside of the valve sleeve 61 are an annular groove 63, which is connected via a fluid path (not illustrated in any more detail) in the housing 25 and in the closure screw 62 to the pressure port 14 of the variable-displacement pump 10 and forms the valve pressure port, and an annular groove 64, which is connected via a fluid path (not illustrated in any more detail) in the housing 25 and in the closure screw 62 to the tank 3 and forms the tank port of the pressure-regulating valve. The valve sleeve 61 has an axial bore 65 which is fluidically connected via radial bores to the annular grooves 63 and 64, which is open toward the actuation chamber 51 and whose mouth opening 66 forms the regulation port of the pressure-regulating valve. A regulating piston 67 is axially movable in the bore 65 and has a blind bore 68 which is open toward the mouth opening 66 of the valve sleeve and which is fluidically connected via radial bores to an annular groove 69 which passes around the regulating piston 67 at the outside.

Owing to the fact that the axial bore 65 of the valve sleeve 61 is open toward the actuation chamber 51, the regulating piston 67 is acted on in one movement direction by the actuation pressure prevailing at the regulation port 66 and in the actuation chamber 51. A valve spring 70 which is clamped between the valve sleeve and the regulating piston 67 acts on the regulating piston 67 in the same direction. The proportional electromagnet 59 acts on the regulating piston 67 in a pushing manner counter to the actuation pressure force generated by the actuation pressure and counter to the spring force of the valve spring 70. When there is an equilibrium between the forces acting on it, the regulating piston 67 assumes a regulation position in which it closes off the radial bores in the valve sleeve 61 with an overlap close to zero, so that the regulation port 66 is shut off both with respect to the valve pressure port 63 and with respect to the tank port 64.

If the electric current flowing through the proportional electromagnet 59 is then increased, the magnetic force becomes larger than the sum of the actuation pressure force and the spring force and the regulating piston 67 is moved from the regulation position in such a direction that the annular groove 63 situated on the outside of the valve sleeve 61 is opened with respect to the annular groove 69 situated on the outside of the regulating piston 67, that is to say that the regulation port 66 is connected to the valve pressure port 63. Pressurized fluid then flows from the pressure port 14 of the variable-displacement pump into the actuation chamber 51 via the valve pressure port 63 and the regulation port 66, so that the adjustment piston 46 extends and the delivery volume of the variable-displacement pump is increased. Thus, the variable-displacement pump then delivers a greater amount into the pressure line 15, which leads to an increase in the rotational speed of the hydraulic motor 17 and of the fan impeller 18 and, in accordance with the fan characteristic curve, to an increase in the pump pressure. Consequently, it is also the case that the pressure in the counter chamber 52 and, in accordance with the rule that the load determines the pressure, the actuation pressure in the actuation pressure chamber 51 are increased. Ultimately, with increasing pump pressure, the actuation pressure becomes so high that the sum of the increased actuation pressure force and the spring force of the valve spring 70 is equal to the magnetic force. In this case, the regulating piston 67 has returned to its regulation position. A pump pressure dependent on the magnetic force and thus a rotational speed of the fan impeller 18 dependent on the magnetic force have been set.

If the electric current flowing through the proportional electromagnet 59 is decreased, the magnetic force becomes smaller than the sum of the actuation pressure force and the spring force and the regulating piston 67 is moved from the regulation position in such a direction that the annular groove 64 situated on the outside of the valve sleeve 61 is opened with respect to the annular groove 69 situated on the outside of the regulating piston 67, that is to say that the regulation port 66 is connected to the tank port 64. Then, with inflow of pressurized fluid from the pressure port 14 of the variable-displacement pump 10 into the counter chamber 52, pressurized fluid is displaced from the actuation chamber 51 via the regulation port 66 and the tank port 64 of the pressure-regulating valve 60, so that the adjustment piston 46 retracts and the delivery volume of the variable-displacement pump is reduced. Thus, the variable-displacement pump then delivers a smaller amount into the pressure line 15, which leads to a decrease in the rotational speed of the hydraulic motor 17 and of the fan impeller 18 and, in accordance with the fan characteristic curve, to a decrease in the pump pressure. Consequently, it is also the case that the pressure in the counter chamber 52 and the actuation pressure in the actuation pressure chamber 51 are decreased. Ultimately, with decreasing pump pressure, the actuation pressure becomes so high that the sum of the reduced actuation pressure force and the spring force of the valve spring 70 is equal to the reduced magnetic force. In this case, the regulating piston 67 has returned to its regulation position. A pump pressure dependent on the magnetic force and thus a rotational speed of the fan impeller 18 dependent on the magnetic force have again been set.

It is thus possible in a simple manner for the rotational speed of the fan impeller 18 to be set by the magnitude of the electric current flowing through the proportional electromagnet 59. The proportional electromagnet 59 activated by an electronic control unit 75 which fixes the rotational speed of the fan impeller 18 according to the cooling power requirement. For accurate control, the rotational speed of the fan impeller 18 can, as is illustrated in FIG. 1, be detected by a rotational speed sensor 76, which is fitted for example in the hydraulic motor 17, and reported to the control unit 75.

As mentioned above, the actuation surface 43, acted on by the actuation pressure, at the adjustment piston 46 is approximately three times as large as the counter surface 44, which is acted on by the pump pressure. Owing to the actuation spring 55, the pump pressure is not in each case three times as large as the actuation pressure, but rather is increased beyond three times the magnitude by the pressure equivalent of the actuation spring 55. If the proportional electromagnet 59 is not in an electrically energized state, a certain pump pressure, and thus a certain rotational speed of the fan impeller, is set according to the strength of the actuation spring 55. If an actuation spring 55 of sufficiently low strength is used, then it is also possible for a standstill of the fan impeller 18 to be obtained if the proportional electromagnet 59 is not in an electrically energized state.

The pressure-regulating valve 60 is one with an upward-sloping characteristic curve. The larger the electric current flowing through the proportional electromagnet 59, the higher the regulation pressure prevailing at the regulation port is. The result of this behavior is that, if the proportional electromagnet is not in an electrically energized state, the actuation pressure is zero and the rotational speed of the fan impeller is dependent solely on the force of the actuation spring 55. Here, the strength of the actuation spring 55 is at least of such a size that, with the variable-displacement pump at a standstill, the swashplate 28 is pivoted to the maximum pivot angle, so that, when the variable-displacement pump is put into operation, a pump pressure is built up quickly.

If, by contrast, with the pressure-regulating valve not in an electrically energized state, the delivery volume of the variable-displacement pump is to be maximal, then use is made of an adjustable pressure-regulating valve 80 with a downward-sloping characteristic curve, like one illustrated in FIGS. 3 and 4. The circuit diagram in FIG. 3 clearly shows that, in the case of a pressure-regulating valve with a downward-sloping characteristic curve, the magnetic force of a proportional electromagnet 59, together with the pressure force exerted by the regulation pressure, acts on a regulating piston 85 counter to the force of a high-strength valve spring 87. Here, in a static state, the sum of the magnetic force and the pressure force can only ever be as high as the spring force, so that, if the magnetic force is zero, the pressure becomes maximal.

A pressure-regulating valve 80 with a downward-sloping characteristic curve and with a pushing proportional electromagnet 59 is illustrated in FIG. 3. The axial bore 65 in the valve sleeve 61 is closed off with respect to the actuation chamber 51. Situated in the valve sleeve are a radial bore 81 which is fluidically connected to a valve pressure port 63, a radial bore 82 which is connected to a tank port 64, and a radial bore 83 which, at the inside, opens into the axial bore 65 axially centrally between the radial bores 81 and 82 and, at the outside, opens into an eccentrically arranged axial bore formed in the valve sleeve 61, which axial bore is open toward the actuation chamber 51 and can be regarded as a regulation port 66 of the valve. A regulating piston is axially displaceable in the bore 65 and, in a regulation position, by way of a piston collar, closes off the radial bore 83 with almost zero overlap. The spaces 86 and 88 before the two face sides of the regulating piston 85 are sealed off with respect to the radial bores 81 and 82 via two further piston collars. The space 86 which is situated before that face side of the regulating piston 67 which faces toward the proportional electromagnet 59 is fluidically connected via the axial bore 84 to the regulation port of the pressure-regulating valve 80, so that said face side and also the interior of the proportional electromagnet 59 is acted on by the actuation pressure prevailing at the regulation port 66. The actuation pressure force generated by the actuation pressure at the regulating piston 85 therefore has the same direction of action as the magnetic force. Actuation pressure force and magnetic force act on the regulating piston 85 in such a direction that, proceeding from the regulation position, a movement in this direction leads to a fluidic connection of the regulation port 66 to the tank port 64. Counter to the sum of the actuation pressure force and the magnetic force, the regulating piston 85 is acted on by a high-strength valve spring 87 which is situated before the other face side of the regulating piston 85 in the space 88. Under the action of the actuation spring 87, the regulating piston 85 moves in such a direction that the regulation port 66 is connected to the valve pressure port 63. The space 88 is connected via a fluid path within the regulating piston 85 to the tank port 64.

If the pressure-regulating valve 80 is used instead of the pressure-regulating valve 60, the actuation pressure and thus the pump pressure and the rotational speed of the fan impeller become lower if the current flowing through the proportional electromagnet 59 is increased and the magnetic force thereby becomes larger. It is also the case that the actuation pressure and thus the pump pressure and the rotational speed of the fan impeller become larger if the current flowing through the proportional electromagnet 59 is decreased and the magnetic force thereby becomes smaller. The actuation pressure and the pump pressure and thus the rotational speed of the fan impeller 18 are maximal with the proportional electromagnet not in an electrically energized state.

### LIST OF REFERENCE SIGNS

10 Variable-displacement pump
11 Suction port of 10
12 Suction line
13 Tank
14 Pressure port of 10
15 Pressure line
16 Pressure port of 17
17 Hydraulic motor
18 Fan impeller
19 Tank port of 17
20 Tank line
21 Check valve
25 Housing of 10
26 Housing pot of 25
27 Port plate of 25
28 Swashplate
29 Drive shaft
30 Cylinder drum
31 Inner toothing of 30
32 Piston bores in 30
33 Displacement piston
34 Sliding shoe
35 Retraction plate
36 Retraction ball
37 Control plate
43 Actuation surface at 46
44 Counter surface at 46
45 Adjustment device of 10
46 Double-action adjustment piston
47 Piston rod of 46
48 Transverse bore in 47
49 Spherical cap
50 Housing bore
51 Actuation chamber
52 Counter chamber
55 Actuation spring
59 Proportional electromagnet
60 Pressure-regulating valve
61 Valve sleeve of 60
62 Closure screw
63 Annular groove on the outside of 61
64 Annular groove on the outside of 61
65 Axial bore in 61
66 Mouth opening of 65
67 Regulating piston
68 Blind bore in 67
69 Annular groove on the outside of 67
70 Valve spring
75 Electronic control unit
76 Rotational speed sensor
80 Pressure-regulating valve
81 Radial bore
82 Radial bore
83 Radial bore
84 Axial bore
85 Regulating piston
86 Space before face side of 85
87 Valve spring
88 Space before face side of 85

1. A hydraulic fan drive comprising:
a variable-displacement pump configured for adjustment of a delivery volume and including (i) a suction port by which a pressurized fluid is sucked in, and (ii) a pump pressure port by which the pressurized fluid is delivered, a pump pressure prevails at the pump pressure port;
an adjustment device configured to adjust the delivery volume, the adjustment device including (i) an actuation chamber delimited by an actuation surface of an adjustment piston, and (ii) an actuation spring, the actuation surface configured to be acted on by an actuation pressure and to which the pressurized fluid is supplied for increasing the delivery volume and from which, under a force generated by the pump pressure, the pressurized fluid is displaced for reducing the delivery volume, the actuation spring is configured to act to adjust the delivery volume toward an extreme value;
a proportionally adjustable pressure-regulating valve including (i) a valve pressure port fluidically connected to the pump pressure port, (ii) a tank port, and (iii) a regulation port at which the actuation pressure is adjusted and which is fluidically connected to the actuation chamber; and
a regulating piston configured to be acted on by a pressure force exerted by the actuation pressure, by a magnetic force generated by a proportional electromagnet, and by a spring force exerted by a spring,
wherein when forces acting on the regulating piston are in equilibrium, the regulating piston assumes a regulation position in which the regulating piston shuts off the regulation port with respect to the valve pressure port and the tank port,
wherein when the regulating piston is outside the regulation position, the regulating piston connects the regulation port to the valve pressure port or to the tank port, and
wherein the actuation spring is configured to act so as to adjust the delivery volume toward a maximum value.

2. The hydraulic fan drive according to claim 1, wherein a counter chamber is acted on by the pump pressure, the counter chamber delimited by a counter surface of an adjustment piston that is smaller in cross section in comparison with the actuation surface.

3. The hydraulic fan drive according to claim 2, wherein:
the actuation chamber and the counter chamber are situated on opposite sides of the adjustment piston,
the adjustment piston is configured as a differential piston,
a piston rod is operably connected to the adjustment piston adjacent the counter chamber, and
the piston rod is configured to mechanically couple the adjustment piston to a component which determines, by way of its position, the delivery volume of the variable-displacement pump.

4. The hydraulic fan drive according to claim 2, wherein:
the adjustment piston is received in a housing bore of a housing of the variable-displacement pump,
the pressure-regulating valve includes a cartridge valve with an insertion cartridge inserted into the housing bore coaxial with the adjustment piston, and
the actuation spring is clamped between the adjustment piston and the pressure-regulating valve.

5. The hydraulic fan drive according to claim 4, wherein the insertion cartridge is received in an outer valve housing and is, in a manner closing off, together with the outer valve housing, the housing bore, inserted into the latter.

6. The hydraulic fan drive according to claim 4, wherein:
the insertion cartridge comprises an insertion sleeve having a central longitudinal bore which is open axially toward the actuation chamber and in which the regulating piston is moved axially and whose opening forms the regulation port of the pressure-regulating valve,
the regulating piston is a hollow piston with a central blind bore which extends in a longitudinal direction and which is open toward the actuation chamber and which is connected by way of at least one radial aperture through the regulating piston to the valve pressure port and to the tank port, and
the actuation pressure acts on the regulating piston in a direction of a connection of the blind bore, and thus of the regulation port, to the tank port.

7. The hydraulic fan drive according to claim 6, wherein:
a valve spring is configured to act on the regulating piston together with the actuation pressure in the direction of the connection of the blind bore, and thus of the regulation port, to the tank port, and
the proportional electromagnet is configured to act on the regulating piston in a pushing manner in the direction of the connection of the blind bore, and thus of the regulation port, to the valve pressure port.

8. The hydraulic fan drive according to claim 4, wherein:
a valve spring is configured to act on the regulating piston counter to the actuation pressure in a direction of a connection of the regulation port to the valve pressure port, and
the proportional electromagnet acts on the regulating piston together with the actuation pressure in the direction of the connection of the regulation port to the tank port.

9. The hydraulic fan drive according to claim 8, wherein the proportional electromagnet acts on the regulating piston together with the actuation pressure in a pushing manner in the direction of the connection of the regulation port to the tank port.

10. The hydraulic fan drive according to claim 8, wherein the proportional electromagnet acts on the regulating piston together with the actuation pressure in a pulling manner in the direction of the connection of the regulation port to the tank port.
